(19) United States
(12) Patent Application Publication
(10) Pub. No.: US 2005/0015197 A1
(43) Pub. Date: Jan. 20, 2005

(54) Communication type navigation system and navigation method

(76) Inventors: Shinya Ohtsuji, Tokai (JP); Soshiro Kuzunuki, Hitachinaka (JP); Tadashi Kamiwaki, Tokai (JP); Michio Morioka, Hitachi (JP); Kazumi Matsumoto, Kokubunji (JP)

Correspondence Address: CROWELL & MORING LLP;INTELLECTUAL PROPERTY GROUP, P.O. BOX 14300, WASHINGTON, DC, 20044-4300, US

(21) Appl. No.: 10/487,727

(22) PCT Filed: Apr. 25, 2003
(86) PCT No.: PCT/JP03/05370

(30) Foreign Application Priority Data
Apr. 30, 2002 (JP) 2002-128290
May 1, 2002 (JP) 2002-129848

(51) Int. Cl. G01C 21/34

(52) U.S. Cl. 701/202; 701/209; 340/995.19

(57) ABSTRACT

A communication type navigation system which presents information supporting judgement of a route selection when a user selects a guidance route from a plurality of searched and recommended routes. In response to a route search request from a navigation terminal (60), a navigation information providing server (10) performs a route search and selects a plurality of recommended routes. By using the information (traffic information, weather information, facility information and user profile information) managed and held by the navigation information providing server (10), evaluation information is generated for the plurality of selected and recommended routes. A user at the navigation terminal (6) is made to refer to this evaluation information and to select a desired recommended route from the plurality of recommended routes.

### TECHNICAL FIELD

The present invention relates to a navigation system using communications.

### BACKGROUND ART

A navigation system (hereinafter called a communication type navigation system) has been proposed which is of the type that a navigation information providing server performs a route search or the like and supplies the search results to a navigation terminal mounted on a vehicle. In a general route search, routes satisfying predetermined conditions and/or conditions set by a user are searched from routes interconnecting a departure place and a destination place by using the Dijkstra's algorithm or the like, and the searched routes are presented as recommended routes.

In a communication type navigation system, a navigation information providing server collectively manages general information such as traffic information and weather information, user profiles such as user preferences at navigation terminals, history information of route guidance adopted at navigation terminals, and other information.

An object of the invention is to allow a user at a navigation terminal in a communication type navigation system to select a useful recommended route by using information under the management by a navigation information providing server.

### DISCLOSURE OF THE INVENTION

In order to solve the above-described issue, the communication type navigation system of this invention has at least one navigation terminal and a navigation information providing server connected to the navigation terminal.

The navigation information providing server comprises: reception means for receiving a route search request from the navigation terminal; search means for searching a route between a departure place and a destination place contained in the route search request and selecting a plurality of recommended routes; evaluation means for forming evaluation information of the plurality of recommended routes selected by the search means by using information held by the navigation information providing server; and presentation means for presenting the navigation terminal transmitted the route search request with route information of the plurality of recommended routes selected by the search means along with the evaluation information formed by the evaluation means.

The navigation terminal comprises: transmission means for transmitting the route search request containing the information of the departure place and the destination place to the navigation information provided server; reception means for receiving the route information of the plurality of recommended routes from the navigation information providing server along with the evaluation information of the plurality of recommended routes; and presentation means for presenting a user with the route information of the plurality of recommended routes along with the evaluation information received at the reception means.

The evaluation information includes, for example, an evaluation of an estimated running time of each of the plurality of recommended routes selected by the search means. The estimated running time of each route can be calculated by using the information of each road section constituting the route and the estimated running time information of each road section held by the navigation information providing server. If the navigation information providing server has an estimated running time at a congested road section, this information is considered when the estimated running time is calculated.

The evaluation information includes, for example, an evaluation of a road roll of each of the plurality of recommended routes selected by the search means. The road toll of each route can be calculated by using the information of each road section constituting the route and road toll information at each road section held by the navigation information providing server.

The evaluation information includes, for example, an evaluation of weather at each of the plurality of recommended routes selected by the search means. The weather at the route can be identified from weather information in a district where each road section constituting the route passes through, by making the navigation information providing server hold the weather information in each district.

The evaluation information includes, for example, an evaluation of running environment (road width and the number of right and left turns) at each of the plurality of recommended routes selected by the search means. The route running environment can be calculated from the road width at each road section and an angle (number of right and left turns) between adjacent road sections constituting the route, respectively held by the navigation information providing server.

The evaluation information includes, for example, an evaluation of a distance to a facility registered beforehand in correspondence with a user at the navigation terminal. This evaluation can be formed by checking whether the route passes through the district having the facility.

The evaluation information includes, for example, an evaluation of an adoption record of each of the plurality of recommended routes selected by the search means to route guidance. For the adoption record to the route guidance, the navigation information providing server acquires information of a recommended route adopted to the route guidance by the navigation terminal and stores this information in correspondence with a user at the navigation terminal.

With the above structure of the invention, a user at the navigation terminal can obtain evaluation information of a plurality of recommended routes formed by using the information held by the navigation information providing server. By referring to the evaluation information, a desired recommended route can be selected from the plurality of recommended routes and adopted as the route guidance. According to the invention, therefore, information instructive for a user at the navigation terminal in selecting a guidance route from a plurality of recommended routes can be presented by using the information held by the navigation information providing server.

In the present invention, the presentation means may supply the evaluation information formed by the evaluation means to the navigation terminal as voice information. In this case, the presentation means notifies the user of the evaluation information by voices.

### BRIEF DESCRIPTION OF THE DRAWINGS

FIG. 1 is a schematic diagram showing a communication type navigation system according to a preferred embodiment of the invention.

FIG. 2 is a schematic diagram showing the structure of a navigation terminal of the communication type navigation system.

FIG. 3 is a schematic diagram showing the structure of an information providing server.

FIG. 4 is a schematic diagram showing the structure of a route search server.

FIG. 5 is a schematic diagram showing the structure of a portal server.

FIG. 6 is a diagram showing an example of the contents registered in a user profile file DB 208 of the portal server.

FIG. 7 is a diagram illustrating the operation procedure to be executed by the communication type navigation system according to the preferred embodiment of the invention.

FIG. 8 is a diagram illustrating the operation procedure to be executed by the communication type navigation system, following the operation illustrated in FIG. 7.

FIG. 9 is a diagram illustrating the operation procedure to be executed by the communication type navigation system, following the operation illustrated in FIG. 8.

FIG. 10 is a diagram showing an example of a selection screen for recommended routes displayed on a monitor of a navigation terminal of the communication type navigation system according to the preferred embodiment of the invention.

FIG. 11 is a diagram showing an example of a display screen to be used when a recommended route displayed on the monitor is selected.

FIG. 12 is a diagram showing the structure of a command/object convertor unit of the portal server of the communication type navigation system according to the preferred embodiment of the invention.

FIG. 13 is a diagram showing the structure of a dialog processor unit.

FIG. 14 is a flow chart illustrating the operation of a command correction reception process to be executed by the portal server of the communication type navigation system according to the preferred embodiment of the invention.

FIG. 15 is a diagram illustrating the operation sequence of a voice recognition system to be used when a navigation terminal requests an information providing server for a route search process.

FIG. 16 is a diagram illustrating the operation sequence of the voice recognition system to be used when the navigation terminal requests the information providing server for the route search process.

### BEST MODE FOR CARRYING OUT THE INVENTION

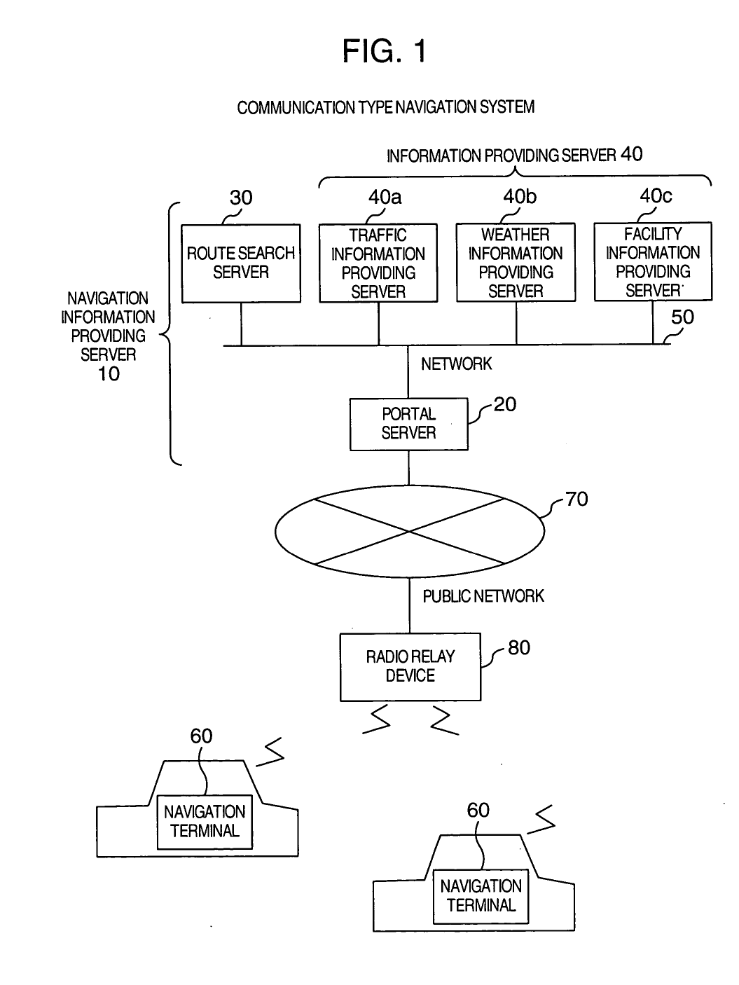

FIG. 1 is a schematic diagram showing a communication type navigation system according to a preferred embodiment of the invention. As shown, in the communication type navigation system of this embodiment, a navigation terminal 60 and a navigation information providing server 10 are interconnected via a public network 70. The navigation terminal 60 is a mobile terminal mounted on a vehicle or the like, and is connected to the public network 70 via a radio relay device 80.

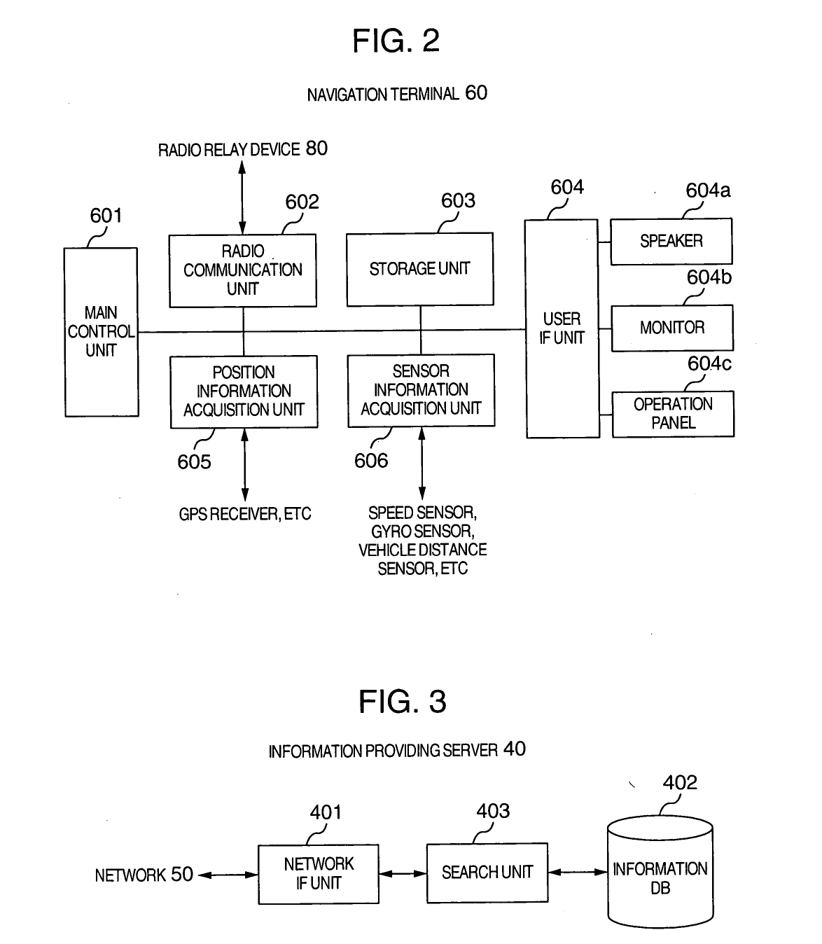

FIG. 2 is a schematic diagram showing the structure of the navigation terminal 60. As shown, the navigation terminal 60 has: a radio communication unit 602 for connection to the public network 70 via the radio relay device 50 through wireless communications; a storage unit 603 for storing various information; a position information acquisition unit 605 for acquiring vehicle position information by using, for example, a GPS receiver; a sensor information acquisition unit 606 for acquiring sensor information from various sensors such as a speed sensor and a gyro sensor mounted on the vehicle; a user I/F unit 604 for exchanging information with a user; and a main control unit 601 for controlling each unit for the navigation process including a route guidance.

The user IF unit 604 has a speaker 604a for voice output, a display monitor 604b and an operation panel 604c for instruction reception. The operation panel 604c has switches for operation instruction reception, touch sensors in the monitor 604b, a microphone for voice input, and the like. By using these constituent elements, the user IF unit 604 exchanges information with the user by using voices and images. The operation buttons, switches, microphone and the like may obviously be structured separated from the operation panel 604c. The navigation terminal 60 having the above-described structure may be a portable computer system and can be realized by making a CPU execute a predetermined program stored in a ROM. This portable computer system includes the CPU, a RAM, the ROM, a radio communication device or an interface to the radio communication device, interfaces with various sensors, and an input/output device such as a display, operation buttons, a microphone and a speaker.

The navigation information providing server 10 supplies the navigation terminal 60 with route information of recommended routes and its evaluation information. The navigation providing server 10 is constituted of a portal server 20, a route search server 30 and an information providing server 40 (a traffic information providing server 40a, a weather information providing server 40b and a facility information providing server 40c), respectively connected via a dedicated network 50.

In response to a search request from the portal server 20, the information providing server 40 performs an information search process and transmits the detected information to the portal server 20. In this embodiment, provided as the information providing server 40 are the traffic information providing server 40a which provides traffic information, the weather information providing server 40b which provides weather information and the facility information providing server 40c which provides facility information.

FIG. 3 shows an outline structure of each information providing server 40. As shown, each information providing server 40 is constituted of: a network IF unit 401 for connection to the network 50, an information database (DB) 402; and a search unit 403 for searching the information DB 402 in accordance with a search request received from the network IF unit 401.

If the information providing server 40 is the traffic information providing server 40a, DB 402 registers therein information of a congested road section and information of an estimated running time of the congested road section. If the information providing server 40 is the weather information providing server 40b, DB 402 registers therein weather information of each district. If the information providing server 40 is the facility information providing server 40c, DB 402 registers therein information of each facility in each district (attribute information such as type, name, address, and contact department).

In response to a route search request from the portal server 20, the route search server 30 performs a route search process and selects a plurality of recommended routes. The root search server 30 transmits the route information of selected recommended routes to the portal server 20.

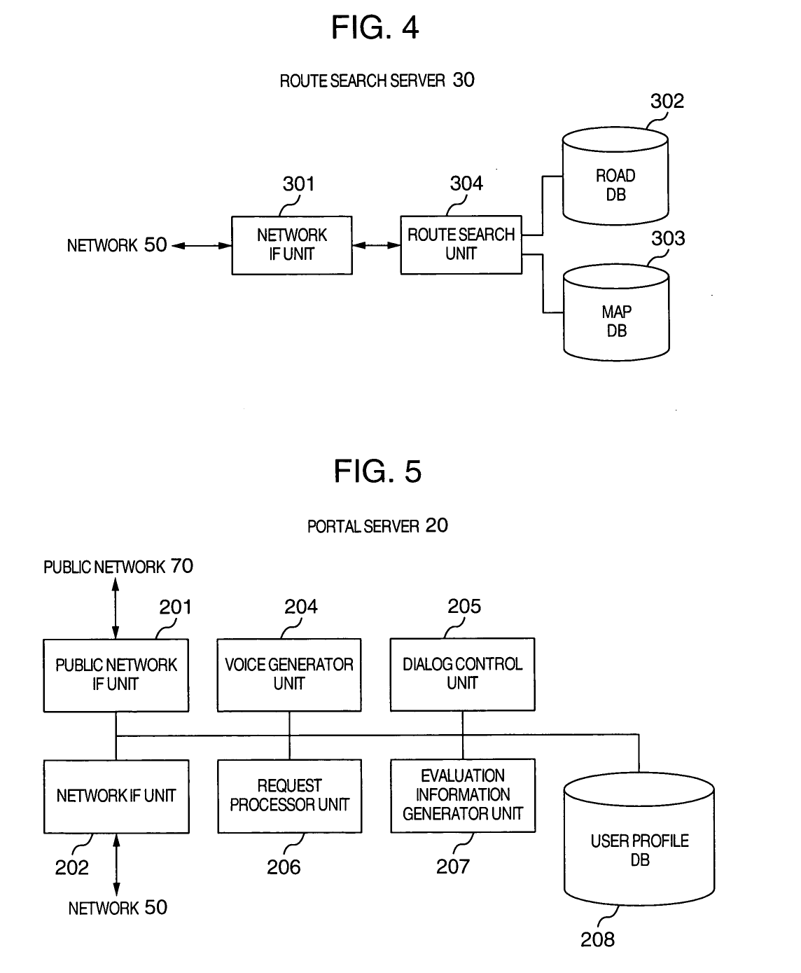

FIG. 4 shows an outline structure of the route search server 30. As shown, the route search server 30 has: a network IF unit 301 for connection to the network 50; a road DB 302 for registering information of each road section, a map DB 303 for registering map information; and a route search unit 304 for selecting a plurality of recommended routes satisfying predetermined conditions from the road DB 302 and map DB 303 by using the Dijkstra's algorithm for example, in accordance with the route search request received via the network IF unit 401.

A plurality of recommended routes are selected because it is intended to make a user at the navigation terminal 60 select a desired recommended route which is useful for the user. In this embodiment, information of each road section registered in the road DB 302 includes an estimated running time, a road toll, a road width and the like.

In response to a route search request from the navigation terminal 60 via the public network 70, the portal server 20 acquires the route information of a plurality of recommended routes from the route search server 30, and if necessary, acquires information from the information providing server 40, and creates evaluation information of the plurality of recommended routes. The portal server 20 transmits the route information of the plurality of recommended routes and its evaluation information to the navigation terminal 60.

FIG. 5 shows the outline structure of the portal server 20. As shown, the portal server 20 has: a public network IF unit 201 for connection to the public network 70; a network IF unit 202 for connection to the network 50; a voice generator unit 204 for generating voice data; a dialog control unit 205 for controlling a dialog with the user at the navigation terminal 60; a request processor unit 206 for transmitting a request to the route search server 30 and information providing server 40 via the network interface 202 and acquiring a process result corresponding to the request; an evaluation information generator unit 207 for generating evaluation information of the plurality of recommended routes acquired from the route search server 30; and a user profile DB 208 for registering user profiles of users at navigation terminals 60.

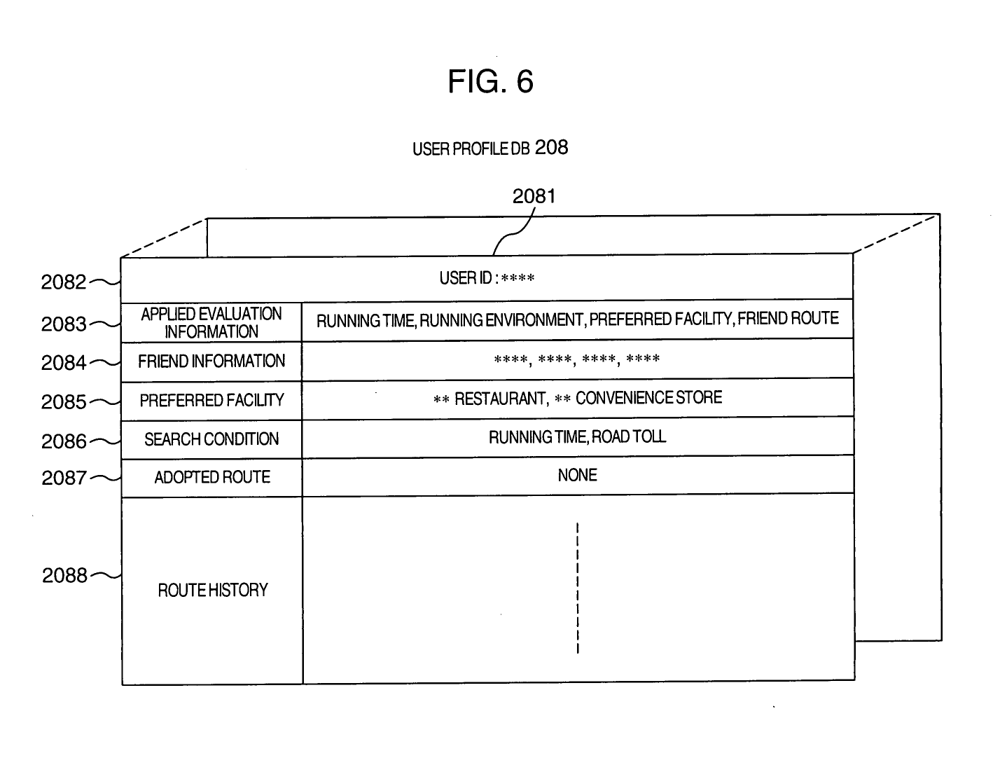

FIG. 6 shows an example of the contents registered in the user profile DB 208. As shown, the user profile DB 208 has a table 2081 for each user at the navigation terminal 60 to register therein user profiles. The table 2081 is constituted of: an ID field 2082 for registering its user ID (identification information); an applied evaluation information field 2083 for registering the type of evaluation information to be generated by the evaluation information generator unit 207; a friend ID field 2084 for registering a user ID of a friend or the like; a preferred facility field 2085 for registering a preferred facility such as a favorite shop; a search condition field 2086 for registering a search condition used by the route search server 30 for the route search process; an adopted field 2087 for registering the route information of a recommended route adopted during route guidance (the route information including the information of a departure place, a transit place, a destination place, road section, a departure time at the departure place, estimated arrival times at the transit and destination places, and the like); and a route history field 2088 for registering the route information of recommended routes used in the past during route guidance (the route information including the information of the departure place, transit place, destination place, road section and the like).

The types of evaluation information to be registered in the applied evaluation information field 2083, prepared in this embodiment, include: a running time, a road toll, a weather state, a running environment, respectively of each recommended route; a distance (facility distance) to a facility registered in the preferred facility field 2085; an adoption record to route guidance; and a similarity degree (route similarity degree) relative to the recommended routes adopted to the route guidance for the navigation terminal 60 of the user ID registered in the friend ID field 2084.

The dialog control unit 205 transmits voices to the navigation terminal 60 via the public network IF unit 201 by using the voice generator unit 204. The dialog control unit 205 also exchanges information with the user via GUI (Graphical User Interface) of the navigation terminal 60 by utilizing XML (extensible Markup Language), CGI (Common Gateway Interface) or JAVA (registered trademark). In this manner, while a dialog with the user at the navigation terminal 60 is controlled, the route search request is acknowledged. In accordance with the acknowledged route search request and the information in the user table 2081 registered in the user profile DB 208, the request processor unit 206 and evaluation information generator unit 207 are controlled to acquire the information of a plurality of recommended routes and its evaluation information, and these information is transmitted to the navigation terminal 60 which transmitted the route search request.

The portal server 20, route search server 30 and information providing server 40 having the above-described structure may be a computer system and can be realized by making a CPU execute a predetermined program stored in an HDD or the like. This computer system includes the CPU, a RAM, the HDD, a network interface and a user interface such as a display and operation buttons. In this case, each DB described above can use a storage device such as HDD.

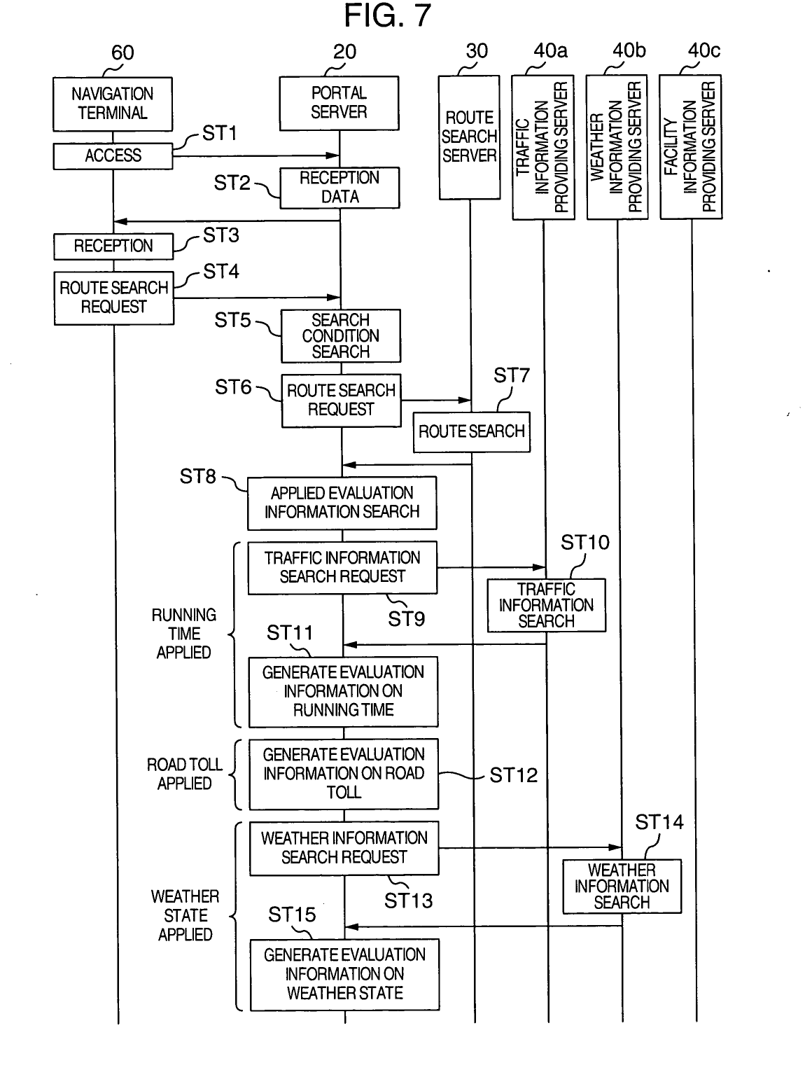

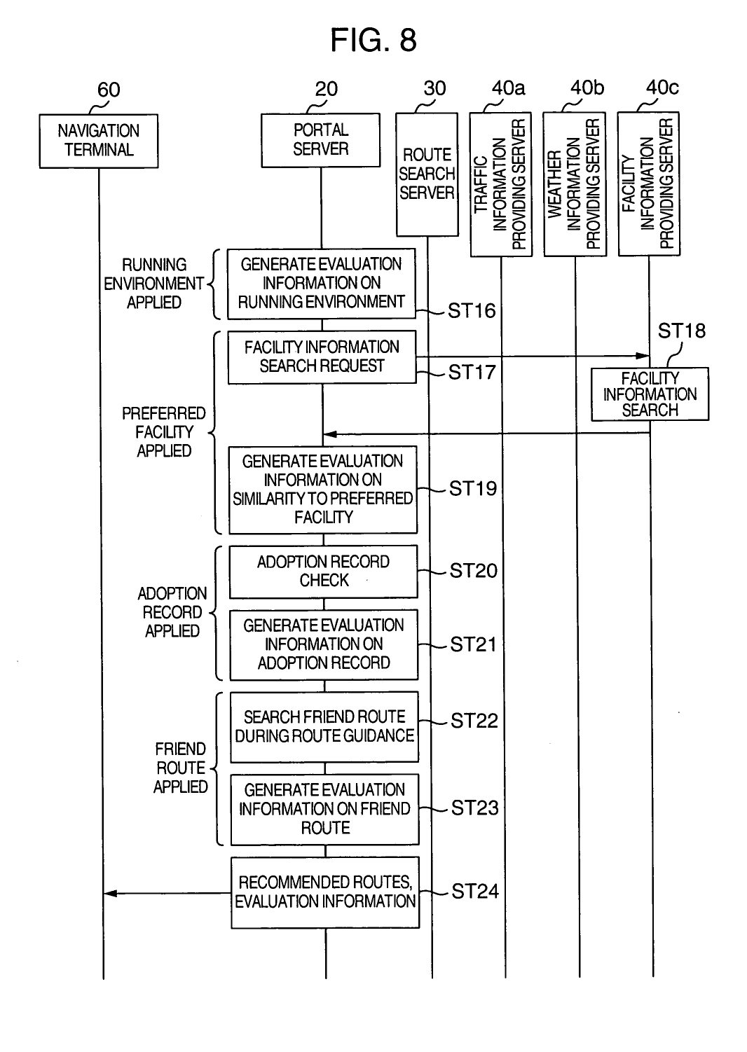

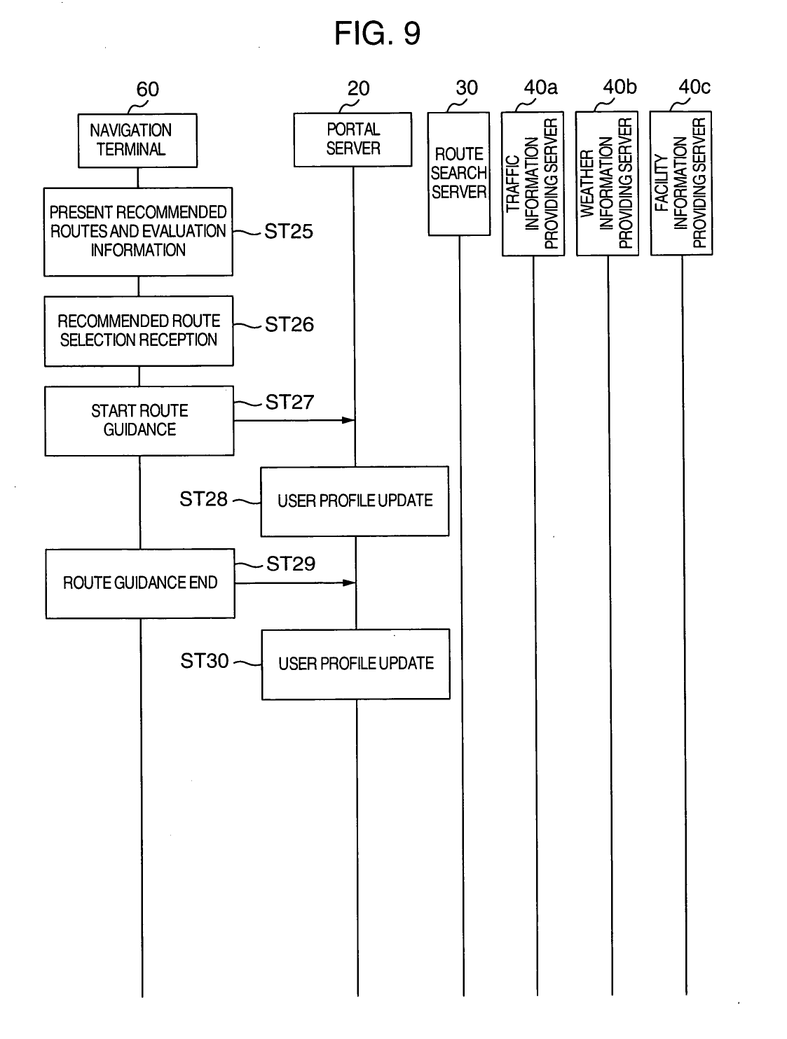

Next, description will be made on the operation of the communication type navigation system of this embodiment. FIGS. 7 to 9 are diagrams illustrating the operation procedure of the communication type navigation system shown in FIG. 1. At the navigation terminal 60, the main control unit 601 controls the radio communication unit 602 to access the portal server 20, in accordance with an instruction entered by the user via the user IF unit 604 (ST 1).

At the portal server 20, when the navigation terminal 50 accesses the portal server 20 via the public network IF unit 201, the dialog control unit 205 controls the voice generator unit 204 to generate voice data (e.g., voice data representative of “Please set destination place”) requesting to input information necessary for the route search. This voice data together with the display screen data to be used for accepting an input of information (including information of a destination place) necessary for the route search is transmitted to the accessed navigation terminal 60 via the public network IF unit 201 (ST 2).

At the navigation terminal 60, the main control unit 601 receives the voice data and display screen data from the portal server 20 via the radio communication unit 602 and passes these data to the user IF unit 604. In response to this, the user IF unit 604 outputs voices represented by the voice data from the speaker 604a and displays the screen represented by the display screen data on the monitor 604b. It stands by until the user enters the destination information via the operation panel 604c (ST 3). When the destination information is input, the user IF unit 604 notifies this information to the main control unit 601. The main control unit 601 then acquires present location information from the position information acquisition unit 605 to use it as departure place information. The main control unit 601 generates a route search request and transmits it to the portal server 20 via the radio communication unit 602 (ST 4). The route search request contains the departure place information, the destination place information received from the user IF unit 604 and the user ID stored beforehand in the storage unit 603 for example.

At the portal server 20, upon reception of the route search request from the navigation terminal 60 via the public network IF unit 201, the dialog control unit 205 passes the route search request to the request processor unit 206. The request processor unit 206 extracts the table 2081 from the user profile DB 208 (ST 5), the table having the ID field 2082 registering the user ID contained in the route search request passed from the dialog control unit 205. The search condition contained in the search condition field 2086 of the extracted table 2081 is added to the route search request received from the navigation terminal 50, and this route search request is transmitted to the route search server 30 via the network IF unit 202 (ST 6).

At the route search server 30, upon reception of the route search request from the portal server 20 via the network IF unit 301, the route search unit 304 searches the routes between two places identified by the departure place and destination place information contained in the search request, by using the road DB 302 and map DB 303. Among the searched routes, a plurality of recommended routes are selected which best satisfy the search conditions contained in the search request, by using the Dijkstra's algorithm or the like. In this embodiment, two recommended routes are selected. Route information of each of the selected recommended routes is transmitted to the portal server 30 via the network IF unit 301 (ST 7). In this embodiment, the route information of each recommended route contains the information of an estimated running time, a road toll and a road width of each road section constituting the route. As described earlier, these information is stored in advance in the road DB 302.

At the portal server 20, upon reception of the route information of each recommended route from the route search server 30 via the network IF unit 202, the request processor unit 206 checks the type of the evaluation information registered in the applied evaluation information field 2083 of the table 2081 extracted from the user profile DB 208 (ST 8).

At ST 8 if the applied evaluation information field 2083 of the extracted table 2081 registers the “running time”, the request processor unit 206 generates a traffic information search request for each road section constituting each recommended route obtained from the route search server 30. This traffic information search request is transmitted to the traffic information providing server 40a via the network IF unit 202 (ST 9).

At the traffic information providing server 40a, upon reception of the traffic information search request from the portal server 20 via the network IF unit 401, the search unit 403 checks from the information DB 402 whether there is any congestion at each road section contained in the traffic information search request. If there is a congested road section, traffic information including the estimated running time of the congested road section is transmitted to the portal server 20 via the network IF unit 401 (ST 10).

At the portal server 20, upon reception of the traffic information from the traffic information providing server 40a via the network IF unit 202, the request processor unit 206 passes the traffic information along with the route information of two recommended routes received from the route search server 30 to the evaluation information generator unit 207 to instruct the evaluation information generator unit 207 to generate evaluation information of the running time. In response to this, the evaluation information generator unit 207 calculates an estimated running time of each recommended route by considering the traffic information. More specifically, estimated running times of the road sections of each recommended route are added together to calculate the estimated running time of each recommended route. If the traffic information contains the estimated running time, this estimated running time is used for this road section. For the road sections whose estimated running times are not contained in the traffic information, the estimated running times contained in the route information of the recommended routes are used.

After the evaluation information generator unit 207 calculates the estimated running time of each recommended route in the above manner, the evaluation information generator unit 207 calculates an estimated running time difference between the recommended routes. The evaluation information generator unit 207 generates the evaluation information which contains the explanation of the estimated running time of each recommended route and the explanation of the estimated running time difference between-the recommended routes (ST 11).

More specifically, the evaluation information is generated by inserting the estimated running time of each recommended route and the estimated running time difference between the recommended routes into predetermined positions of a message prepared beforehand. It is assumed for example that the prepared message is “Estimated running time of recommended route A is &quot; a &quot;. Estimated running time of recommended route B is &quot;. Recommended route &quot; c &quot can reach faster by &quot; d &quot.”. Assuming that the two recommended routes received from the route search server 30 are the recommended route A and the recommended route B, the estimated running time of the recommended route A is inserted into the &quot; a &quot; portion of the message, and the estimated running time of the recommended route B is inserted into the &quot; b &quot; portion of the message. An identifier (either A or B) of the recommended route having a shorter estimated running time is inserted into the $quot; c &quot; portion of the message, and the estimated running time difference between the recommended routes A and B is inserted into the $quot; d &quot; portion of the message.

In this example, although two recommended routes are compared, if there are three or more recommended routes, a message may be created only for the recommended route having the shortest estimated running time as the evaluation information. If the recommended route having the shortest estimated running time is the recommended route A among three recommended routes A, B and C, a message may be prepared in advance, i.e., the message “Estimated running time of recommended route A is &quot; a &quot;. Recommended route A reaches faster by &quot; d &quot;.”. The estimated running time of the recommended route A is inserted into the &quot; a &quot; portion of the message, and a difference between the estimated running time of the recommended route A and the average value of the estimated running times of all recommended routes or the longest estimated running time is inserted into the &quot; d &quot; portion of the message. In this manner, the characteristics of the recommended routes can be presented more clearly than showing the estimated running time independently for each recommended route.

If the estimated running time of a road section contained in the traffic information is used for calculating the estimated running time of each recommended route, a message notifying that the recommended route has a congested road section is created and this message is included in the evaluation information. More specifically, a message notifying a congested road is generated by inserting an identifier of a congested recommended route and a congested road section into predetermined positions of a message prepared beforehand. For example, if the prepared message is “Recommended route &quot; e &quot; has a congested load section &quot; f &quot;”, an identifier of the recommended route whose estimated running time was calculated by using the estimated running time of the road section contained in the traffic information is inserted into the &quot; e &quot; portion of the message, and the name of the road section is inserted into the &quot; f &quot;.

At ST 8 if the applied evaluation information field 2083 of the extracted table 2081 registers the “road toll”, the request processor unit 206 passes the route information of the two recommended routes received from the route search server 30 to the evaluation information generator unit 207 to instruct the evaluation information generator unit. 207 to generate evaluation information regarding the road toll. In response to this, the evaluation information generator unit 207 calculates a road roll of each recommended route. More specifically, the road toll of the recommended route is calculated by adding together the road toll of each road section constituting the recommended route and contained in the route information of the recommended route.

After the evaluation information generator unit 207 calculates the road toll of each recommended route in the above manner, it calculates a road toll difference between the recommended routes. The evaluation information containing the explanation of the road toll of each recommended route and the explanation of the road toll difference between the recommended routes is generated in the manner similar to the evaluation information regarding the running time (ST 12).

A message is generated which notifies the road section incurred with a road toll for the recommended route having the road toll, and this message is included in the evaluation information. In this case, for the recommended route having the road toll, a difference from the highest road toll of the recommended route may be notified.

If both the recommended routes have no road toll (0 Yen), the evaluation information constituted of a message, for example, “Road toll of both recommended routes is free.” may be generated instead of the evaluation information containing the explanation of the road toll of each recommended route and the explanation of the road toll difference between the recommended routes, or the evaluation information regarding the road toll may be omitted.

At ST 8 if the applied evaluation information field 2083 of the extracted table 2081 registers the “weather information”, the request processor unit 206 generates a weather information search request including the information of each road section of the two recommended routes received from the route search server 30. This weather information search request is transmitted to the weather information providing sever 40b via the network IF unit 202 (ST 13).

At the weather information providing server 40b, upon reception of the weather information search request from the portal server 20 via the network IF unit 401, the search unit 403 checks the weather forecast of the district containing the road section included in the weather information search request, by using the information DB 402. The weather information containing the weather forecast of each road section is transmitted to the portal server 20 via the network IF unit 401 (ST 14).

At the portal server 20, upon reception of the weather information from the weather information providing server 40b via the network IF unit 202, the request processor unit 206 passes the weather information along with the root information of the two recommended routes received from the route search server 30 to the evaluation information generator unit 207 to instruct the evaluation information generator unit 207 to generate the evaluation information regarding the weather. In response to this, the evaluation information generator unit 207 generates the evaluation information containing the comparative explanation of the weather forecast between the recommended routes in accordance with the weather information (ST 15). More specifically, the numbers of road sections with bad or good weather forecast are compared between both the recommended routes. In accordance with the comparison result, as the evaluation information a message is generated such as “Worse weather is forecast for recommended route A more than recommended route B.”, “Good weather is forecast for both recommended routes.” and “Bad weather is forecast for both recommended routes.”.

At ST 8 if the applied evaluation information field 2083 of the extracted table 2081 registers the “running environment”, the request processor unit 206 passes the root information of the two recommended routes received from the root search server 30 to the evaluation information generator unit 207 to instruct the evaluation information generator unit 207 to generate the evaluation information regarding the running environment. In response to this, the evaluation information generator unit 207 calculates the running environment of each recommended route. For example, it is checked from the route information of each recommended route how many times right and left turns occur on the recommended route, the right and left turn being able to be identified from the angle between adjacent road sections. A road width average of road sections constituting the recommended route is also calculated. The number of right and left turns and the road width average are used as the running environment.

After the evaluation information generator unit 207 calculates the running environment of each recommended route in the manner described above, it generates the evaluation information containing the comparative explanation of the running environment between the recommended routes (ST 16). More specifically, the numbers of right and left turns and the road width averages are compared between both the recommended routes. In accordance with this comparison result, as the evaluation information, a message is generated such as “It is expected that recommended route A has the smaller number of right and left turns than recommended route B and is easy to run.” and “It is expected that recommended route A has wider road width than recommended route B and is easy to run.”.

At ST 8 if the applied evaluation information field 2083 of the extracted table 2081 registers the “facility distance”, the request processor unit 206 generates a facility information search request which contains the information of each road section of the two recommended routes received from the root search server 30 and the information of a facility name or a facility type registered in the preferred facility field 2085 in the extracted table 2081. This facility information search request is transmitted to the facility information providing server 40c via the network IF unit 202 (ST 17).

At the facility information providing server 40c, upon reception of the facility information search request from the portal serve 20 via the network IF unit 401, the search unit 403 checks from the information DB 402 a facility having the facility name or classified into the facility type, contained in the facility information search request and existing in the district including each road section contained in the facility information search request. The facility information of this facility, in correspondence with the recommended route constituted of the road section in the district where the facility exists, is transmitted to the portal server 20 via the network IF unit 401 (ST 18).

At the portal server 20, upon reception of the facility information from the facility information providing server 40c via the network IF unit 202, the request processor unit 206 passes the facility information along with the route information of the two recommended routes received from the route search server 30 to the evaluation information generator unit 207 to instruct the evaluation information generator unit 207 to generate the evaluation information regarding the facility distance. In response to this, the evaluation information generator unit 207 generates the evaluation information containing the information of the facility and the explanation of the access environment to the facility (ST 19). For example, as the evaluation information, a message is generated such as “There is ** restaurant near recommended route A” if the information of the facility “** restaurant” is in correspondence with the recommended route A.

At ST 8 if the applied evaluation information field 2083 of the extracted table 2081 registers the “adoption record”, the request processor unit 206 passes the root information of the two recommended routes received from the root search server 30 to the evaluation information generator unit 207 to instruct the evaluation information generator unit 207 to generate the evaluation information regarding the adoption record. In response to this, the evaluation information generator unit 207 checks from the user profile DB 208 the frequency of adoption of the route generally coincident with the recommended route, taking into consideration the registration contents of the root history of other users, to thereby check whether each of the two recommended routes received from the route search server 30 has the record of adopting it a predetermined number of times during past route guidance (ST 20).

In accordance with the check results, the evaluation information generator unit 207 generates the evaluation information containing the explanation of the adoption record of the two recommended routes received from the route search server 30 (ST 21). For example, as the evaluation information a message is generated such as “Recommended route A has the adoption record during route guidance.”, if the recommended route A was used in the past during route guidance. In this manner, the user can have a sense of safety that the recommended route has been already supported by several people.

At ST 8 if the applied evaluation information field 2083 of the extracted table 2081 registers the “route similarity”, the request processor unit 206 passes the root information of the two recommended routes received from the root search server 30 to the evaluation information generator unit 207 to instruct the evaluation information generator unit 207 to generate the evaluation information regarding the friend route. In response to this, the evaluation information generator unit 207 checks the user ID registered in the friend ID field 2084 of the extracted table 2081, and further checks the table 2081 (hereinafter called a friend table) whose ID field 2082 resisters the user ID. If the adopted route field 2087 of the friend table 2081 registers the route information, then it is checked whether the destination of the root (called a friend route) identified by the route information is coincident with the destination of the two recommended routes received from the route search server 30. If coincident, a similarity (amount of coincident parts) to the friend route is checked relative to each of the two recommended routes received from the route search server 30 (ST 22).

In accordance with this check results, the evaluation information generator unit 207 generates the evaluation information containing the explanation of the similarity between the friend route and the two recommended routes received from the route search server 30 (ST 23). For example, as the evaluation information, a message is generated such as “Person having user ID ** drives toward the same destination. Recommended route A becomes confluent with route of person having user ID ** at road section **.”, if the recommended route A becomes confluent with the friend route of the user ID ** at the ** road section.

The evaluation information generator unit 207 passes the evaluation information generated in the above manner to the request processor unit 206. The request processor unit 206 passes the evaluation information received from the evaluation information generator unit 207 along with the route information of the two recommended routes received from the route search server 30, to the dialog control unit 205. In response to this, the dialog control unit 205 generates the display data containing the route information of the two recommended routes and the evaluation information. The dialog control unit 205 also controls the voice generator unit 204 to generate the voice data representative of the evaluation information. These data is transmitted to the navigation terminal 60 which transmitted the route search request via the public network IF unit (ST 24).

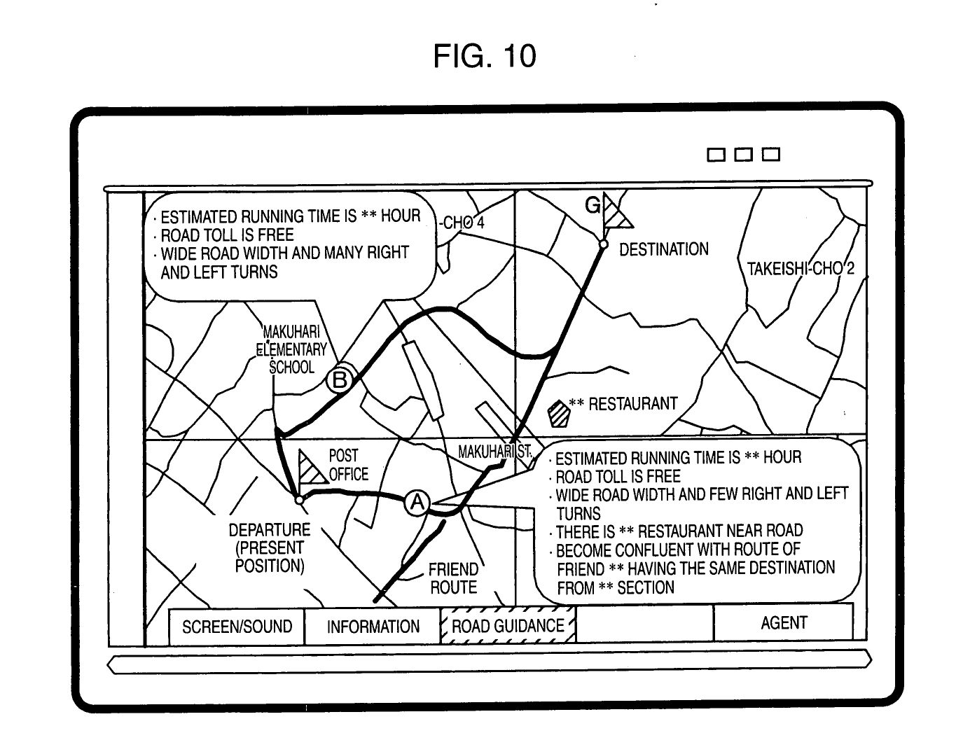

At the navigation terminal 40, upon reception of the voice data and display data from the portal server 20 via the radio communication unit 602, the main control unit 601 passes the voice data and display data to the user IF unit 604. In response to this, the user IF unit 604 outputs voices represented by the voice data from the speaker 604a, and generates selection screen data for making the user select one of the two recommended routes by using the display data and map data stored in the storage unit 603 or the like and displays a selection screen represented by the data on the monitor 604b (ST 25). It stands by until the user inputs a selection instruction for the recommended routes via the operation panel 604c (ST 26). FIG. 10 shows an example of the selection screen displayed on the monitor 604b of the navigation terminal 40. In this example, the two recommended routes A and B along with their evaluation information (a balloon display) are displayed on a map. Also in this example, since the evaluation information regarding the facility distance is included, a mark is displayed indicating a preferred facility “** restaurant” near the recommended route A. Also in this example, since the evaluation information regarding the friend route is included, a friend route having the same destination is displayed which becomes confluent with the recommended route A at an intermediate position. Along with this selection screen, voices of the voice data representative of the evaluation information are output from the speaker 604a. Examples of the message represented by voice data are shown below.

(1) A voice output example of the evaluation information on the running time.

“The estimated running time of the recommended route A is ** hour ** minute. The estimated running time of the recommended route B is ** hour ** minute. It is estimated that the recommended route ** gives a faster arrival by ** minute. The recommended route ** has a congested road section.”

(2) A voice output example of the evaluation information on the road toll.

“The road toll of the recommended route A is ** Yen. The road toll of the recommended route B is ** Yen. The recommended route ** is cheaper by ** Yen.”

(3) A voice output example of the evaluation information on the weather information.

“Bad weather is forecast for the recommended route **.”, “Bad weather (good weather) is forecast for both the recommended routes A and B.”

(4) A voice output example of the evaluation information on the running environment.

“The recommended route ** has the smaller number of right and left turns than the recommended route **, whereas the recommended route ** has a wider road than the recommended route **.”

(5) A voice output example of the evaluation information on the facility information.

“There is a favorite facility “** restaurant” near the recommended route **.”

(6) A voice output example of the evaluation information on the adoption record.

“The recommended route was used for the route guidance in the past.”

(7) A voice output example of the evaluation information on the friend route similarity.

“The person having the user ID ** drives toward the same destination. The recommended route ** becomes confluent with the route of the person having the user ID ** from the road section **.”

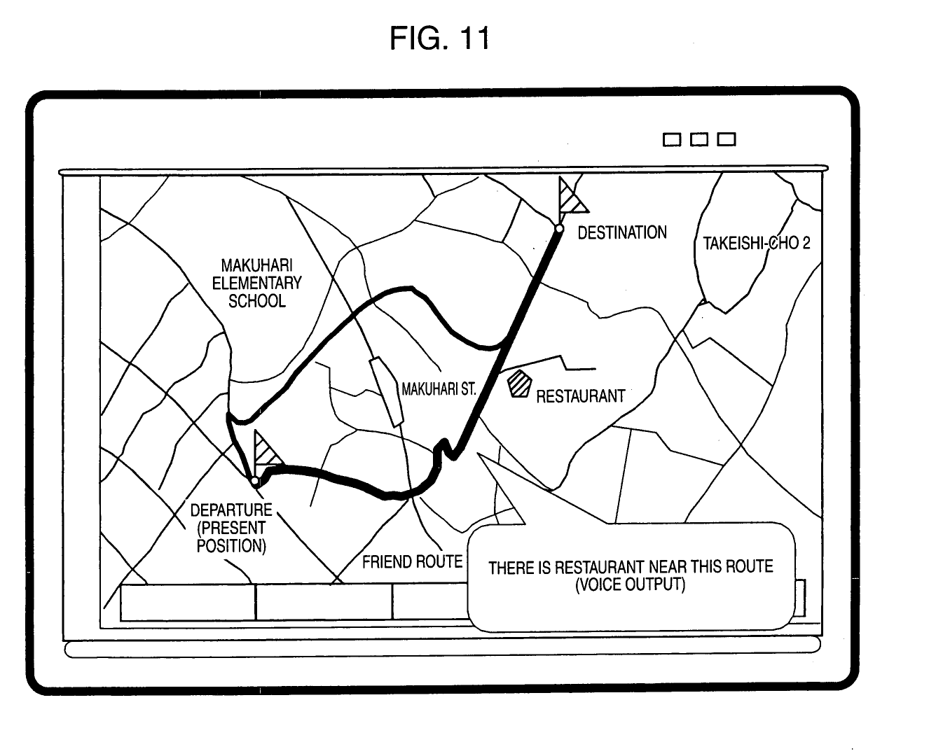

When the information of a plurality of routes is presented to the user, the route display method is changed with the voice output contents in such a manner that the user can know at a glance the display of the route corresponding to the voice output contents during the voice output. As shown in FIG. 11, the route is displayed so that the user can know the route at a glance, for example, the route display is flushed, the route display line is made bold, the color of the route display line is changed to a loud color, and the like.

When the user selects the recommended route in accordance with these information, in addition to a key input using a remote controller, a touch panel or the like, a voice input using a microphone may also be used. In this case, an operation unit such as a button may be mounted near the navigation terminal 60, or for the user convenience, the operation unit such as a button may be mounted in a vehicle operation handle (steering wheel). A voice input microphone may be mounted at a position where voices of the user can be picked up easily, and a speaker may be mounted at a position where the user can listen easily as a dedicated terminal device or a speaker in the vehicle used as an audio apparatus or the like may be used.

When a user selects a recommended route by using voices, the user speaks the contents identifying the recommended route selected from the evaluation information output as voices. When a user misses to listen to the voice output and requests again for the voice output, the user speaks the contents identifying the desired route information. In this case, it can be anticipated that the user speaks a memorized key word in the evaluation information output as voices, it is necessary to perform a proper voice recognition process in order to correctly recognize the user voice input based upon the evaluation information.

Japanese Patent Laid-open Publication No. HEI-11-143493 discloses a voice recognition technique. According to this technique, a voice language interpreter apparatus converts input voices into an intermediate language or database language to search words. Japanese Patent Laid-open Publication No. 2000-57490 discloses a voice recognition technique which improves the recognition performance of input voices by switching between recognition dictionaries. Japanese Patent Laid-open Publication No. 2001-34292 discloses a voice recognition technique which improves the recognition performance by cutting off words in a dictionary by utilizing the technique called word spotting, recognizing request key words to identify a topic, and recognizing the voices by using a recognition dictionary for the identified topic.

The voice recognition technique described in Japanese Patent Laid-open Publication No. HEI-11-143493 converts sentence data into a corresponding intermediate language in order to minimize recognition errors. This uses a method of learning the Hidden Markov Model. Since this method relies upon learning through a statistical process, it is necessary to learn each of a plurality of fields if services are to be presented to these fields. It takes a long process time and a recognition performance lowers. This technique does not consider some errors in a recognition character string. The technique of Japanese Patent Laid-open Publication No. 2000-57490 does not allow a continuous input of voices. It also does not consider some errors in a recognition character string. Similar to the above two conventional techniques, the technique of Japanese Patent Laid-open Publication No. 2001-34292 does not consider some errors in a recognition character string.

In this embodiment, the portal server 20 recognizes voices received from the navigation terminal and converts them into a character string. The converted character string is separated into two portions: a portion (called a command portion) corresponding to a pre-registered character string (a character string representative of the process contents desired by a user as the navigation terminal, hereinafter called a command); and a portion (called a object portion) of the character string other than the command portion (a character string representative of an object of the process contents desired by a user as the navigation terminal, hereinafter called an object). In accordance with the integrity of the character string of the command portion, the command portion is converted into one of pre-registered commands (e.g., a command having the largest number of characters coincident with the character string of the command portion). In accordance with the integrity with the character string of the object portion, the object portion is converted into one of objects of a type pre-registered in correspondence with the converted command (e.g., an object having the largest number of characters coincident with the character string of the object portion).

The portal server 20 transmits the character strings constituted of the converted object and command and/or voices representative of the character strings, to the navigation terminal. An indication whether there is any recognition error in the command and object in this order, is interactively received from the user at the navigation terminal.

Next, if the portal server 20 receives an indication that there is a recognition error in the command, the command portion is converted into another pre-registered command in accordance with the integrity with the original character string (character string during voice recognition) of the command portion. The converted command and/or voices representative of the command are transmitted to the navigation terminal, and an indication whether there is any recognition error in the converted command is interactively received. This process is repeated until an indication that there is no recognition error in the command is received from the user at the navigation terminal. The portal server 20 changes the message to be notified to the navigation terminal to interactively receive an indication whether there is any recognition error, in accordance with the number of indications that there is a command recognition error, received relative to the original character string of the command portion.

If the indication that there is a command recognition error is received the predetermined number of times (e.g., the number of interactive dialog times is three) or more, the user at the navigation terminal is requested to input again the voices representative of the character string of the command portion. The voices input again are recognized and converted into a character string. This character string is used as the character string of the command portion, and converted into one of the command pre-registered in the manner described above. The converted command and/or voices representative of the command are transmitted to the navigation terminal to repeat the process of interactively receiving an indication whether there is any recognition error in the converted command.

If the portal server 20 receives an indication that there is a recognition error in the object, the object portion is converted into another object of the type pre-registered in correspondence with the converted command (command received an indication that there is no recognition error), in accordance with the integrity with the original character string (character string during voice recognition) of the object portion. The converted command and/or voices representative of the object are transmitted to the navigation terminal, and an indication whether there is any recognition error in the converted object is interactively received. This process is repeated until an indication that there is no recognition error in the object is received from the user at the navigation terminal. The portal server 20 changes the message to be notified to the navigation terminal to interactively receive an indication whether there is any recognition error, in accordance with the number of indications that there is an object recognition error, received relative to the original character string of the object portion.

If the indication that there is an object recognition error is received the predetermined number of times (e.g., the number of interactive dialog times is three) or more, the user at the navigation terminal is requested to input again the voices representative of the character string of the object portion. The voices input again are recognized and converted into a character string. This character string is used as the character string of the object portion, and converted into one of the object pre-registered in the manner described above. The converted object and/or voices representative of the object are transmitted to the navigation terminal to repeat the process of interactively receiving an indication whether there is any recognition error in the converted object.

The user is not requested to utter voices repetitively until the indications that there is a recognition error take the predetermined number of times. Therefore, the inconvenience that the user feels when the same voices are uttered often in order to correct the recognition error portion, can be mitigated.

If the voice recognition system of this invention is used in combination with the navigation system, the command corresponds to a character string having a high possibility of being used when an indication for the navigation process is input by voices, such as “set as a destination place”, “set as a transit place” and “register as a registration place”. The object corresponds, for example, to a place name, an address, a facility proper name and the like.

In this invention, a character string obtained through voice recognition of voices entered by a user is separated into the command portion and object portion, and an indication whether there is any recognition error is received from the user for each of the command and object portions. If some of the recognized character string has an error, the recognition error portion can be corrected efficiently.

When an indication that there is not recognition error is received from the navigation terminal for both the command and object, the portal server 20 generates a process request message to be transmitted to the information providing server 40 corresponding to the command contents, in accordance with the combination of the command and object. The generated process request message is transmitted to the information providing server 40.

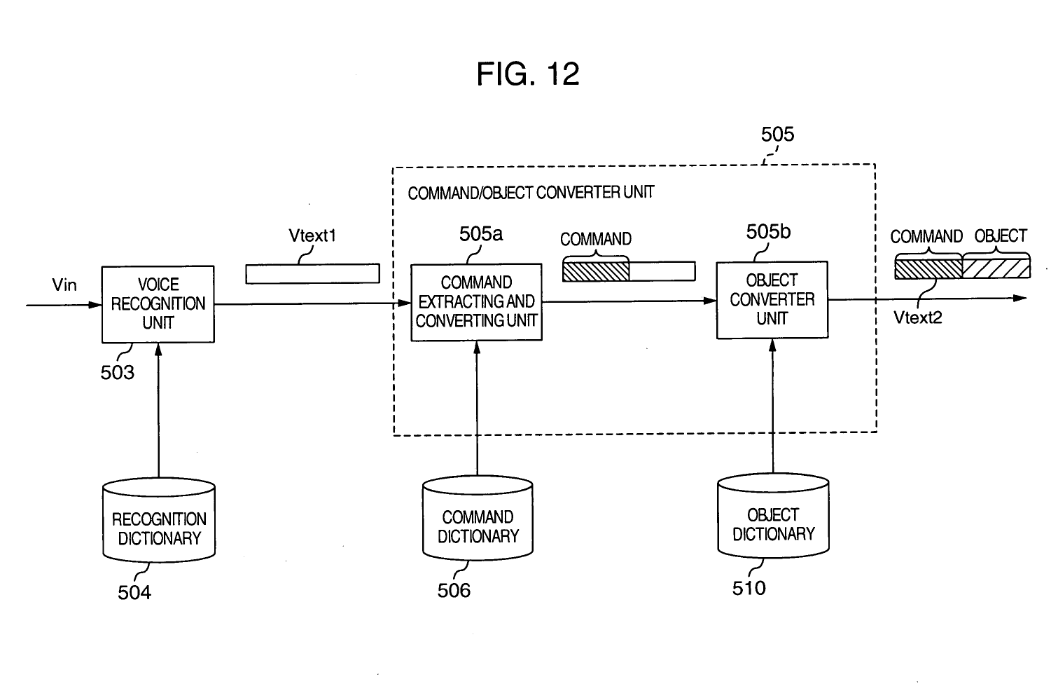

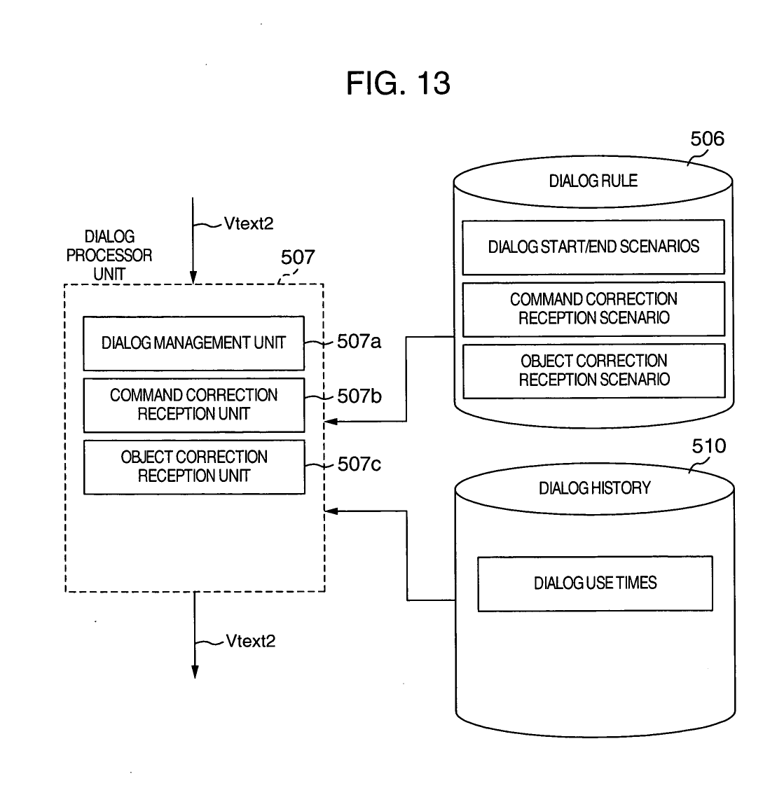

As shown in FIG. 12, a voice recognition unit 503 fetches voice data Vin received at the public network IF unit 201 and executes a voice recognition process for the voice data Vin by using a recognition dictionary 504, to thereby convert the voice data Vin into text (character string) data Vtext1. A recognition dictionary stored in the recognition dictionary 504 may be a recognition dictionary used by available voice recognition techniques.

A command/object converter unit 505 separates the text data Vtext1 output from the voice recognition unit 503 into the command portion and object portion by using a command dictionary 506 and an object dictionary 510. The command portion and object portion are converted into a command and an object registered in the command dictionary 506 and object dictionary 510, respectively, to thereby convert the text data Vtext1 into text data Vtext2.

As shown in FIG. 13, in accordance with a dialog rule stored in a dialog rule storage unit 508 and a dialog history stored in a dialog history storage unit 509, a dialog processor unit 507 corrects the text data Vtext2 output from the command/object converter unit 505 interactively with the user at the navigation terminal, basing upon the voices sent from the navigation terminal.

A command extracting and converting unit 505a extracts the command portion from the text data Vtext1 output from the voice recognition unit 503, and replaces the character string of the extracted command portion with one of the commands stored in the command dictionary. The specific operation is performed in the following manner. In this embodiment, a character string coupling the object and command in this order is assumed as the character string to be entered by a user at the navigation terminal by voices for the process request to the information providing server 40.

First, the command extracting and converting unit 505a extracts one command from the command dictionary 506. Next, a character string having the number of characters of the command is cut off from the text data Vtext1 from the end side thereof. An integrity (coincident character number) between the cut-off character string and the command is checked. If the integrity has a predetermined criterion or more, this command is selected as a candidate command. These processes are performed for all commands registered in the command dictionary 506. The command dictionary 506 stores therein the commands to be used by a user at the navigation terminal for the process request to the information providing server 40, as well as the destination address of the information providing server 40 as the process request destination and a transmission format to be used when a process request is transmitted to the information providing server 40.

Next, the command extracting and converting unit 505a sets the candidate command having the highest integrity among the candidate commands, as a deterministic command to be replaced by the character string of the command portion of the text data Vtext1. The deterministic command along with the text data Vtext1 is passed to the object converter unit 505b. It is assumed that the candidate commands not set as the deterministic command are also held for an interactive correction process to be later described, until an indication is issued from the dialog processor unit 507.

However, the command extracting and converting unit 505a executes the following process if it is instructed by the dialog processor unit 507 to perform only command conversion. Namely, one command is extracted from the command dictionary 506, and the integrity (coincident character number) between the character string of the text data Vtext1 and the extracted command is checked. If the integrity is the predetermined criterion or more, this command is selected as the candidate command. This process is performed for all commands registered in the command dictionary 506. The candidate command having the highest integrity among the candidate commands is set as the deterministic command. The deterministic command is passed to the dialog processor unit 507 as the text data Vtext2. Also in this case, the candidate commands not set as the deterministic command are held until an indication is issued from the dialog processor unit 507.

The object converter unit 505b extracts the object portion from the text data Vtext1 output from the voice recognition unit 503, and replaces the character string of the extracted object portion with one of the objects stored in the object dictionary 510. The specific operation is performed in the following manner. The object dictionary 510 registers therein the objects classified in each type (e.g., a genre such as a place name, a music name and a program name). Each command registered in the object dictionary 510 is set so that it belongs to at least one type.

The object converter unit 505b extracts one object of the type to which the deterministic command set by the object converter unit 505b belongs, from the object dictionary 510. Next, a character string having the number of characters of the deterministic command set by the object converter unit 505b is cut off from the text data Vtext1 from the end side thereof. The integrity (coincident character number) between the cut-off character string and the object is checked. If the integrity takes the predetermined criterion or more, this object is selected as the candidate object. The above processes are performed for all objects of the type registered in the object dictionary 510 and to which type the deterministic command set by the object converter unit 505b belongs.

Next, the object converter unit 505b sets the candidate object having the highest integrity among the candidate objects, as the deterministic object to be replaced by the object portion of the text data Vtext1. The text data Vtext2 is formed by coupling the deterministic command and deterministic object, and passed to the dialog processor unit 507. It is assumed that the candidate objects not set as the deterministic object are also held for the interactive correction process to be later described, until an indication is issued from the dialog processor unit 507. Similarly, the text data Vtext1 is also held until an indication is issued from the dialog processor unit 507.

However, the object converter unit 505b executes the following process if it is instructed by the dialog processor unit 507 to perform only object conversion. Namely, one command of the type to which the deterministic command belongs is extracted from the object dictionary 510, and the integrity (coincident character number) between the character string of the text data Vtext1 and the extracted command is checked. If the integrity takes the predetermined criterion or more, this object is selected as the candidate object. This process is performed for all objects of the type registered in the object dictionary 510 and to which type the deterministic command belongs. The candidate object having the highest integrity among the candidate objects is set as the deterministic object. The deterministic object is passed to the dialog processor unit 507 as the text data Vtext2. Also in this case, the candidate objects not set as the deterministic command are held until an indication is issued from the dialog processor unit 507.

A dialog management unit 507a controls the voice generator unit 204 in accordance with the dialog start/end scenarios stored in the dialog rule storage unit 506, and makes a dialog for correcting the contents of the process request to the information providing server 40 entered by voices by a user at the navigation terminal. The dialog start/end scenarios describe the messages for starting and ending the confirmation whether there is any recognition error in the text data Vtext2 output from the command/object converter unit 505, and a rule such as a presentation timing of these messages.

As described above, in this embodiment the confirmation whether there is any recognition error is made interactively with the user at the navigation terminal, in the order of the command and the object of the text data Vtext2. When the user at the navigation terminal indicates a recognition error of the command, the process is passed to a command correction reception unit 507b,whereas when the user indicates a recognition error of the object, the process is passed to an object correction reception unit 507c.The final deterministic command and object are passed to the request processor unit 206.

The command correction reception unit 507b acquires the candidate command from the command/object converter unit 505. In accordance with a command correction reception scenario stored in the dialog rule storage unit 506 and a dialog history (dialog use number) with the user at the navigation terminal registered in the dialog history storage unit 510, the voice generator unit 204 is controlled to thereby make a dialog for correcting the command portion of the process request to the information providing server 40 entered by voices by the user at the navigation terminal. The command correction reception scenario describes a message of receiving a command change from the user at the navigation terminal, and the rules such as a presentation timing of the message. In this embodiment, the command correction reception scenario describes the following rules.

(1) Confirming whether the presented candidate command is correct or not is performed in the order of the higher integrity of the candidate command.

(2) The message for confirming whether the candidate command is correct or not is changed (specifically, shortened) in accordance with the number of candidate command presentations (i.e., number of recognition errors).

(3) If there is no candidate command or if the number of candidate command presentation times becomes a predetermined time (e.g., three), the user at the navigation terminal is requested to enter again the voices of the command portion of the process request to the information providing server 40.

The object correction reception unit 507c acquires the candidate object from the command/object converter unit 505, and performs a similar process to that of the command generator unit by using the object correction reception scenario. The object correction reception scenario is prepared for each type ID stored in the command dictionary 506 in order to make it easy for the user to grasp the recognition error position. The object command correction reception scenario describes a message of receiving an object change from the user at the navigation terminal, and the rules such as a presentation timing of the message. According to the rules of the object correction reception scenario, the message for confirming whether the object is correct or not is changed with the type of the deterministic command.

In accordance with the command and object received from the dialog management unit 507a and the transmission format registered in the command dictionary 506 in correspondence with the command, the request processor unit 206 generates a process request message to the information providing server 40 whose destination address is registered in the command dictionary 506 in correspondence with the command. This process request message is transmitted to the information providing server 40 at the process request destination. Next, in response to the process request message, the request processor unit 206 transmits the service information received from the information providing server 40 to the user at the navigation terminal.

At the dialog processor unit 507, the dialog management unit 507a instructs the command correction reception unit 507b to perform a command correction reception process. In response to this, the command correction reception unit 507b first sets “1” as the value of a counter n for counting the number of confirmations (dialog use number) whether there is any command recognition error, and the count is stored in the dialog history storage unit (S10101).

Next, the command correction reception unit 507b checks whether the candidate command having the second highest integrity with the command portion of the text data Vtext1, relative to the command presented immediately before to the user at the navigation terminal, is being stored in the command/object converter unit 505 (S10102).

If such a command is being stored, this command is acquired from the command/object converter unit 505 (S10103). In accordance with the command correction reception scenario stored in the dialog rule storage unit 506 and the dialog use number n stored in the dialog history storage unit 509, the command correction reception unit 507b controls the voice generator unit 204 to output voice data representative of the message which contains the character string of the acquired candidate command and requests the confirmation whether there is any command recognition error. The portal server 20 transmits these data to the navigation terminal via the public network IF unit 201 (S10104). As described earlier, in this embodiment the message for the confirmation whether there is any command recognition error is changed with the dialog use number n.

At the navigation terminal, a new command is displayed and output as voices, and the message for the confirmation whether there is any command recognition error is displayed and output as voices. As the user at the navigation terminal inputs voices representative of whether there is any recognition error (“Yes” or “No”) from the navigation terminal, this voice data is transmitted to the portal server 20.

Upon reception of the voice data from the navigation terminal via the public network IF unit 201, the portal server 20 passes the voice data to the voice recognition unit 504. The voice recognition unit 504 performs a voice recognition process to convert the received voice data Vin into the text data Vtext1 by using the recognition dictionary 504. In response to an instruction from the command correction reception unit 507b,the text data Vtext1 is output from the voice recognition unit 504 directly to the command correction reception unit 507b.

By using the text data Vtext1 received from the voice recognition unit 504, the command correction reception unit 507b analyzes whether there is any recognition error of the command received from the user at the navigation terminal (S10105). If this analysis result indicates no command recognition error, the candidate command selected at S10103 is used as the deterministic command (S10114) to thereafter terminate the command correction reception process. If the analysis result indicates that there is a command recognition error, the command correction reception unit 507b increments the dialog use number n stored in the dialog history storage unit 509 by ‘1’ (S10106), and checks whether the value n is the predetermined number (e.g., 3) or larger (S10107). If the value n is not the predetermined number or larger, the flow returns to S10102.

If it is confirmed at S10102 that the candidate command having the second highest integrity with the command portion of the text data Vtext1, relative to the command presented immediately before to the user at the navigation terminal, is not stored in the command/object converter unit 505, or if it is judged at S10107 that the dialog use number n is the predetermined value or larger, then the command correction reception unit 507b controls the voice generator unit 204 in accordance with the command correction reception scenario stored in the dialog rule storage unit 506 to output the voice data and text data representative of the message requesting for inputting again voices representative of the command portion. The portal server 20 transmits these data to the navigation terminal via the public network IF unit 201 (S10108).

At the navigation terminal, the message requesting for inputting again voices representative of the command is displayed and output as voices. As the user at the navigation terminal inputs voices representative of the command from the navigation terminal, this voice data is transmitted to the portal server 20.

Upon reception of the voice data from the navigation terminal via the public network IF unit 201 (S10109), the portal server 20 passes the voice data to the voice recognition unit 504. The voice recognition unit 504 performs a voice recognition process to convert the received voice data Vin into the text data Vtext1 by using the recognition dictionary 504 (S10110). In response to an instruction from the command correction reception unit 507b,the command extracting and converting unit 505a of the command/object converter unit 505 selects the candidate commands from the command portion by using the text data Vtext1 as the command portion, by the method described earlier. The candidate command having the highest integrity among the selected commands is set as the deterministic command (S10111).

In accordance with the command correction reception scenario stored in the dialog rule storage unit 506, the command correction reception unit 507b controls the voice generator unit 204 to output voice data representative of the message which contains the character string of the deterministic command and requests for the confirmation whether there is any recognition error of the deterministic command. The portal server 20 transmits these data to the navigation terminal via the public network IF unit 201 (S10112).

At the navigation terminal, the message for the confirmation whether there is any recognition error of the deterministic command is displayed and output as voices. As the user at the navigation terminal inputs voices representative of whether there is any recognition error (“Yes” or “No”) from the navigation terminal, this voice data is transmitted to the portal server 20.

Upon reception of the voice data from the navigation terminal via the public network IF unit 201, the portal server 20 passes the voice data to the voice recognition unit 504. The voice recognition unit 504 performs a voice recognition process to convert the received voice data Vin into the text data Vtext1 by using the recognition dictionary 504. In response to an instruction from the command correction reception unit 507b, the text data Vtext1 is output from the voice recognition unit 504 directly to the command correction reception unit 507b.

By using the text data Vtext1 received from the voice recognition unit 504, the command correction reception unit 507b analyzes whether there is any recognition error of the deterministic command received from the user at the navigation terminal (S10113). If this analysis result indicates a recognition error of the deterministic command, the process continues returning back to S10101. If the analysis result indicates no recognition error of the deterministic command, the command correction reception process is terminated.

The operation of the object correction reception process is similar to the command correction reception process. However, at the processes corresponding to S10108 and S10112, in accordance with the object correction reception scenario stored in the dialog rule storage unit 506 in correspondence with the type ID of the deterministic command, the object correction reception unit 507c controls the voice generator unit 204 to output voice data representative of the message requesting for inputting again voices representative of the object portion or the message for requesting for confirming whether there is any recognition error of the deterministic object.

Next, at the portal server 20, in accordance with the dialog start/end scenarios stored in the dialog rule storage unit 506, the dialog control unit 507a controls the voice generator unit 204 to output voice data representative of the message which contains the character string representative of the deterministic command and requesting for confirming whether there is any recognition error of the deterministic command. These data is transmitted to the navigation terminal via the public network IF unit 201 (S1904). The voice data and text data representative of the message to be used for confirming whether there is any recognition error of the command portion of the voice data received from the navigation terminal, are therefore transmitted from the portal server 20 to the navigation terminal. In this example, the command portion of the voice data is recognized erroneously. The message and text indicate “Please answer by Yes or No. The following contents are correct for the command recognition ? (set as the registration place)”.

At the navigation terminal, the message represented by the voice data received from the portal server 20 is output as voices from the speaker 604a and the message represented by the text data is displayed on the monitor 604b. As a message “No” representative of that there is a recognition error, is input as voices from the microphone, this message is transmitted to the portal server 20 (S1905).

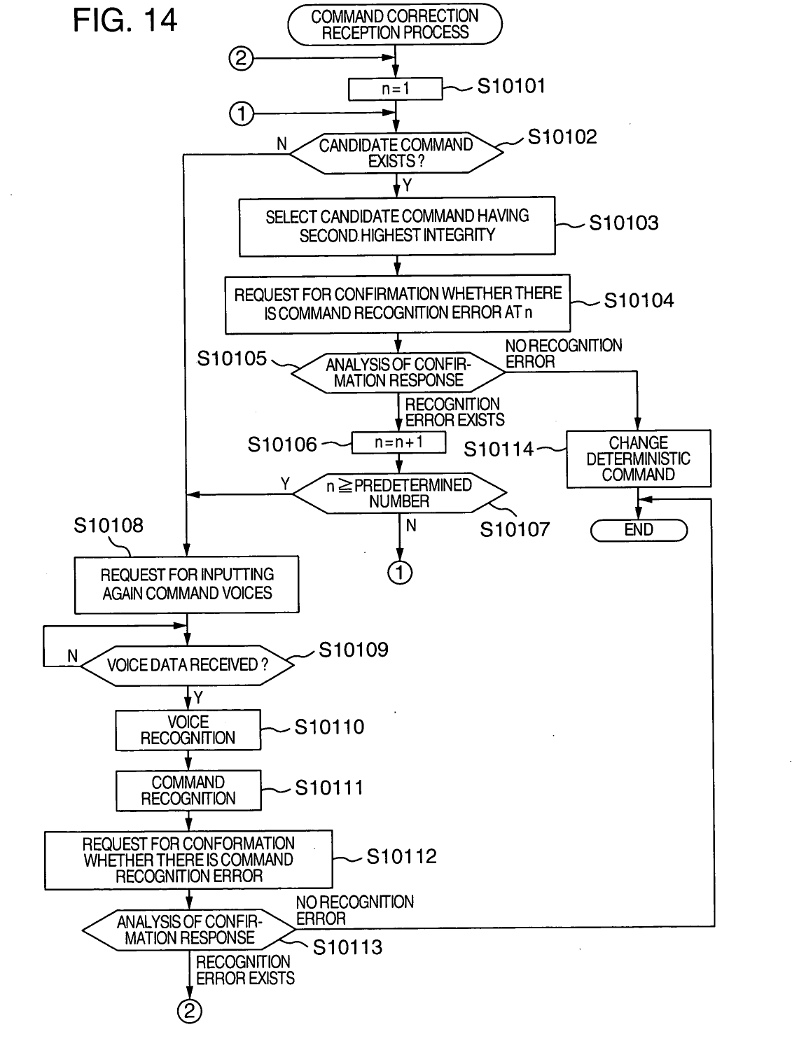

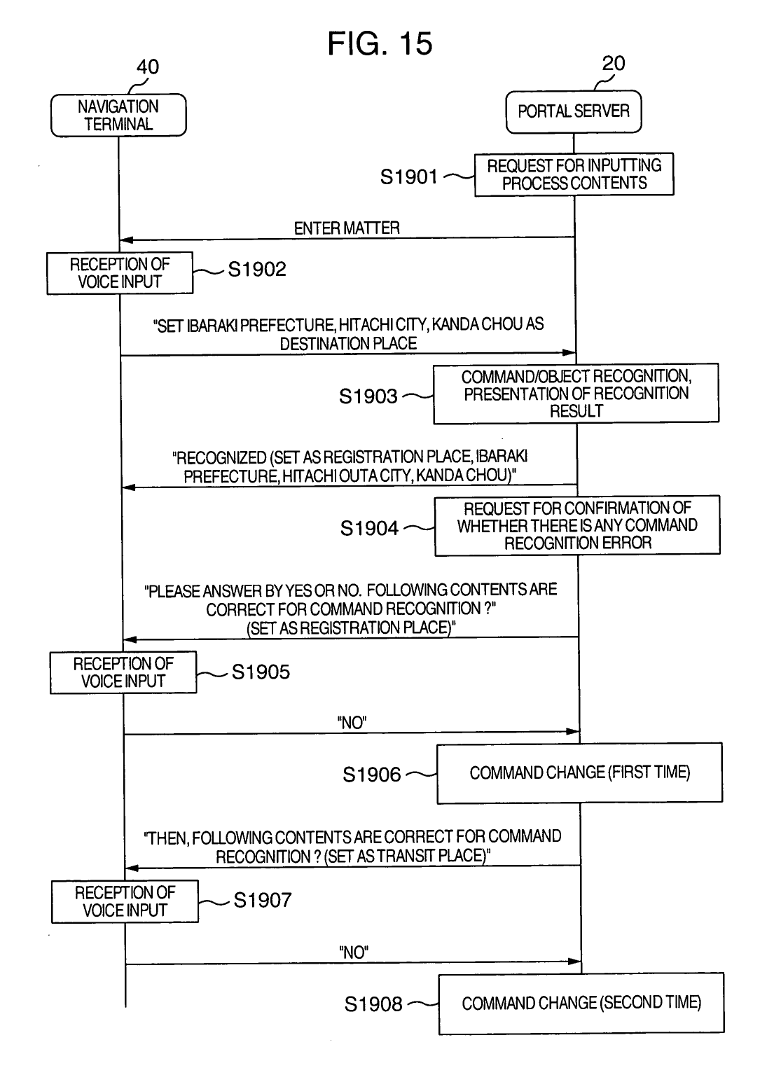

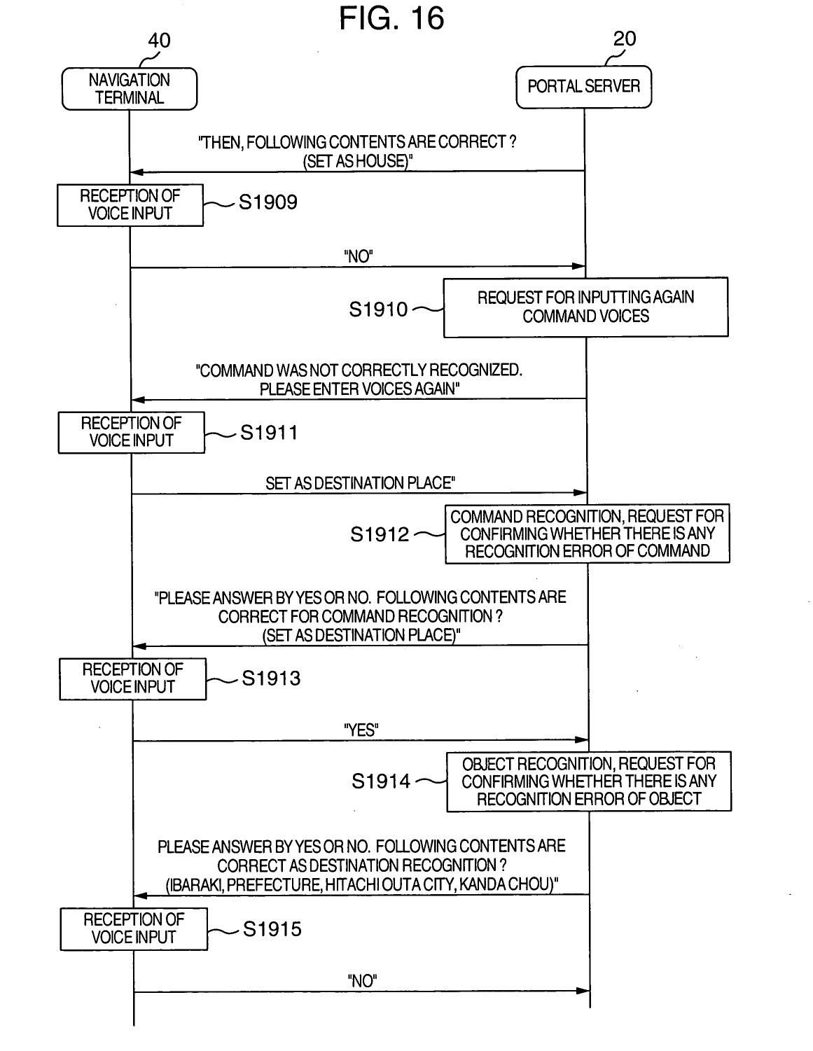

Next, upon reception of the voice data from the navigation terminal, the portal server 20 passes this voice data to the voice recognition unit 503. The voice recognition unit 503 performs a voice recognition process by using the recognition dictionary 504 to convert the received voice data Vin into the text data Vtext1. In response to an instruction from the dialog management unit 507a, this text data Vtext1 is output from the voice recognition unit 503 directly to the dialog management unit 507a. By using the text data Vtext1 received from the voice recognition unit 503, the dialog management unit 507a analyzes whether there is any recognition error of the deterministic command received from the user at the access terminal. If it is confirmed that the message from the navigation terminal indicates that “there is a recognition error”, the processes from S10101 to S10104 shown in FIG. 14 are performed (S1906). With these processes, a command having the second highest integrity relative to the “set as the registration place” is selected for the voice data received from the navigation terminal. The voice data and text data of the message intended to confirm whether there is any recognition error of the command portion of the voice data are transmitted from the portal server 20 to the navigation terminal. In this example, a newly selected command is also erroneous. The message and text are “Then, the following contents are correct for the command recognition ? (set as the transit place)”. As described earlier, in this embodiment the message intended to confirm whether there is any recognition error of the command portion is changed with the dialog use number n. Specifically, the larger the value n, the shorter the message is made.

At the navigation terminal, the voice data and text data received from the portal server 20 are output. As a message “No” representative of that there is again a recognition error, is input as voices from the microphone, this message is transmitted to the portal server 20 (S1907).

Next, similar to the above, as the message from the navigation terminal indicates that “there is a recognition error”, the portal server 20 performs the command change process for the second time (S1908). With this process, a command having the second highest integrity relative to the “set as the registration place” is selected for the voice data received from the navigation terminal. In this example, it is assumed that the newly selected command is also erroneous. The message and text corresponding to the command are “Then, the following contents are correct ? (set as the own house)”.

At the navigation terminal, the voice data and text data received from the portal server 20 are output. As a message “No” representative of that there is a recognition error, is input as voices from the microphone, this message is transmitted to the portal server 20 (S1909).

Next, at the portal server 20, as it is confirmed that the message from the navigation terminal indicates again that “there is a recognition error”, it means that the dialog use number n is the predetermined number (in this case, 3) or larger, so that a voice re-enter request process at S10108 shown in FIG. 14 is performed (S1910). The voice data and text data of the message requesting the user at the navigation terminal to again input voices of the command portion, are transmitted from the portal server 20 to the navigation terminal. In this example, the message and text are “Command cannot be correctly recognized. Please enter voices again.”.

At the navigation terminal, the voice data and text data received from the portal server 20 are output. As a character string of the command portion “Set as the destination place”, is input as voices, this character string is transmitted to the portal server 20 (S1911).

Next, the portal server 20 performs the processes from S10109 to S10112 shown in FIG. 14 (S1912). With these processes, the voice data and text data of the message intended to confirm whether there is any recognition error of the command portion received again from the navigation terminal, are transmitted from the portal server 20 to the navigation terminal. In this example, the message and text are “Please answer by Yes or No. The following contents are correct for the command recognition ? (set as a destination place)”.

At the navigation terminal, the voice data and text data received from the portal server 20 are output. As a message “Yes” representative of that there is no recognition error, is input as voices, this voice data is transmitted to the portal server 20 (S1913).

Next, the portal server 20 performs the confirmation response analysis process shown at S10113 in FIG. 14 and if it is confirmed that the message from the navigation terminal indicates “no recognition error”, then the character string of the command portion is eventually defined as “set as the destination place”.

The portal server 20 then follows the confirmation request process of confirming whether there is any recognition error of the object. At this process, the voice data and text data of the message intended to confirm whether there is any recognition error of the object portion of the voice data received from the navigation terminal, are transmitted from the portal server 20 to the navigation terminal. In this example, the object portion of the voice data has a recognition error. The message is “Please answer by Yes or No. The following contents are correct for object recognition ? (Ibaragi Prefecture, Hitachi Outa City, Kanda chou)” (S1914).

At the navigation terminal, the voice data and text data received from the portal server 20 are output. As a message “No” representative of that there is a recognition error, is input as voices, this voice data is transmitted to the portal server 20 (S1915). Thereafter, the object change process is performed in the manner similar to the command recognition.

In this embodiment, the portal server 20 changes the message (command correction reception scenario) for receiving the information on whether there is an object recognition error, in accordance with the type ID of the deterministic command. For example, if the deterministic command relates to destination place setting, the message is changed to “The following contents are correct for the destination place ? . . . ”, and if the deterministic command relates to registration place setting, the message is changed to “The following contents are correct for the registration place ? . . . ”. With such an arrangement, the user can easily and quickly grasp which recognition error is to be checked.

In the above-described embodiment, the portal server 20 separates the voice recognition result of voices representative of a process request to the information providing server 40, into the command portion and object portion. After the command portion and object portion are converted into the command and object, the user is requested to confirm whether there is any recognition error. The portal server 20 may extract the command portion from the voice recognition result to request the user to confirm whether there is any recognition error, and thereafter may extract the object portion to request the user to confirm whether there is any recognition error.

As selection information of the recommended routes is input from the user, the user IF unit 604 notifies this information to the main control unit 601. In response to this, the main control unit 601 starts the route guidance by using the selected recommended route, and transmits the information of the selected recommended route along with its own user IF to the portal server 20 via the radio communication unit 602 (ST 27).

At the portal server 20, upon reception of the information of the recommended route adopted for the route guidance along with the user ID from the navigation terminal 60 via the public network IF unit 201, the dialog control unit 205 identifies the table 2081 whose ID field 2082 registers the user ID, and registers the information of the recommended route in the adopted route field 2087 of this table 2081 (ST 28).

Thereafter, at the navigation terminal 60, after the vehicle reaches the destination place and the route guidance is completed, the main control unit 601 transmits a route guidance completion notice along with its own user ID to the portal server 20 via the radio communication unit 602 (ST 29).

At the portal server, upon reception of the route guidance completion notice from the navigation terminal 60 via the public network IF unit 201, the dialog control unit 205 identifies the table 2081 whose ID field 2082 registers the user ID included in the notice, and deletes the information of the recommended route registered in the adopted route field 2087 of this table 2081 (ST 30).

In this embodiment, a user at the navigation terminal 60 can obtain evaluation information of a plurality of recommended routes formed by using the information (traffic information, weather information, facility information, user profile information) managed and held by the navigation information providing server 10. By referring to the evaluation information, a desired recommended route can be selected from the plurality of recommended routes. According to the embodiment, therefore, information instructive for a user at the navigation terminal 60 in selecting a guidance route from a plurality of recommended routes can be presented by using the information managed and held by the navigation information providing server 10.

In the embodiment, the navigation information providing server 10 has the configuration that the portal server 20, route search server 30 and information providing server 40 are interconnected by the dedicated network 50. The navigation information providing server 10 may have the configuration that the servers 20 to 40 are interconnected by the public network 70, or the configuration that the servers 20 to 40 are implemented on one computer system. For example, the information providing server 40 may be implemented on the same computer system of the portal server 20.

The evaluation information described in the embodiment is only illustrative. The evaluation information is sufficient only if it is useful for a user at the navigation terminal 60 in selecting a desired recommended route and can be formed from the information managed and held by the navigation information providing server 10.

### INDUSTRIAL APPLICABILITY

As above, the navigation system of the invention is suitable for a car navigation system which searches a guidance route and guides a vehicle.

1. A communication type navigation system in which a navigation server searches a route in response to a route search request from a terminal, wherein:
said navigation server comprises:
reception means for receiving from said terminal;
search means for searching a route between a departure place and a destination place contained in said route search request and selecting a plurality of recommended routes;
evaluation means for forming evaluation information of comparison between estimated running times of the plurality of recommended routes selected by said search means; and
presentation means for presenting said terminal transmitted said route search request with route information of the plurality of recommended routes selected by said search means along with the evaluation information formed by said evaluation means;
said terminal comprises:
transmission means for transmitting said route search request containing the departure place and the destination place to said navigation server;
reception means for receiving the route information of the plurality of recommended routes from said navigation server along with said evaluation information for the plurality of recommended routes; and
presentation means for presenting a user with the route information of the plurality of recommended routes along with said evaluation information received at said reception means; and
wherein said presentation means outputs said evaluation information as voice information.

2. A navigation server in a communication type navigation system in which a route is searched in response to a route search request from a terminal, wherein:
said navigation server comprises:
reception means for receiving from said terminal;
search means for searching a route between a departure place and a destination place contained in said route search request and selecting a plurality of recommended routes;
evaluation means for forming evaluation information of comparison between the plurality of recommended routes selected by said search means; and
presentation means for presenting said terminal transmitted said route search request with route information of the plurality of recommended routes selected by said search means along with the evaluation information formed by said evaluation means; and
wherein said evaluation means forms the evaluation information of comparison of estimated running times between the plurality of recommended routes selected by said search means.

3. The navigation server in the communication type navigation system according to claim 2, wherein said evaluation means further forms the evaluation information of the estimated running times of the plurality of recommended route in accordance with traffic congestion at each of the plurality of recommended routes selected by said search means.

4. The navigation server in the communication type navigation system according to claim 2, wherein said evaluation means further forms the evaluation information of a road toll at each of the plurality of recommended routes selected by said search means, in accordance with information of a road toll at each road section.

5. The navigation server in the communication type navigation system according to claim 2, wherein said evaluation means further forms the evaluation information of weather at each of the plurality of recommended route in accordance with weather information in a district where the plurality of recommended routes selected by said search means pass through.

6. The navigation server in the communication type navigation system according to claim 2, wherein said evaluation means further forms the evaluation information of running environment by obtaining a road width and the number of right and left turns of each of the plurality of recommended routes selected by said search means.

7. The navigation server in the communication type navigation system according to claim 2, wherein said evaluation means further forms the evaluation information of a distance to a facility from any one of the plurality of recommended routes selected by said search means, by using information of said facility registered beforehand in correspondence with a user at said terminal.

8. The navigation server in the communication type navigation system according to claim 2, wherein said evaluation means further forms the evaluation information of an adoption record of each of the plurality of recommended routes selected by said search means, adopted to route guidance, in accordance with information of a recommended route adopted in the past.

9. A navigation method for a terminal connected to a said navigation server comprises steps of:
receiving a route search request from said terminal;
searching a route between a departure place and a destination place contained in said route search request and selecting a plurality of recommended routes;
forming evaluation information of the plurality of recommended routes; and
presenting route information of the plurality of recommended routes along with the evaluation information to said terminal transmitted said route search request; and
said terminal comprises steps of:
transmitting the route search request to said navigation server; and
presenting a user with the route information and evaluation information of the plurality of recommended routes received from said navigation server in response to said route search request.
